(19) United States
(12) Patent Application Publication
(10) Pub. No.: US 2026/0184138 A1
(43) Pub. Date: Jul. 2, 2026

(54) VEHICLE AIR CONDITIONING SYSTEM

(71) Applicants: HYUNDAI MOTOR COMPANY, Seoul (KR); KIA CORPORATION, Seoul (KR)

(72) Inventors: Sang Yeop Lee, Hwaseong-si (KR); Jae Won Heo, Hwaseong-si (KR); Seung Hoon Moon, Hwaseong-si (KR); Jung Mo Kwak, Hwaseong-si (KR); Young Su Nam, Hwaseong-si (KR); Myung Jun Kim, Hwaseong-si (KR); Jin Han Kim, Hwaseong-si (KR); Young Taek Hong, Hwaseong-si (KR); Gyeong Won Jeong, Hwaseong-si (KR); Kyeong Min Kang, Hwaseong-si (KR); Sang Shin Lee, Hwaseong-si (KR); Hae Ryong Park, Hwaseong-si (KR)

(73) Assignees: HYUNDAI MOTOR COMPANY, Seoul (KR); KIA CORPORATION, Seoul (KR)

(21) Appl. No.: 19/294,082

(22) Filed: Aug. 7, 2025

(30) Foreign Application Priority Data
Dec. 30, 2024 (KR) 10-2024-0199528

(51) Int. Cl. B60H 1/34; B60H 1/24

(52) U.S. Cl. CPC B60H 1/3421; B60H 1/246

(57) ABSTRACT

A vehicle air conditioning system includes: an air conditioner case, a cam mounted to the air conditioner case, a first lever unit having one end coupled to the cam, a second lever unit disposed adjacent to the first lever unit and having one end coupled to the cam, a first door unit coupled to another end of the first lever unit and configured to open and close a first foot vent, and a second door unit coupled to another end of the second lever unit and configured to open and close a second foot vent. In particular, the first door unit and the second door unit are arranged coaxially with each other and are rotated in conjunction with the cam via the first lever unit and the second lever unit.

### CROSS-REFERENCE TO RELATED APPLICATION

This application claims, under 35 U.S.C. § 119(a), the benefit of and priority to Korean Patent Application No. 10-2024-0199528, filed on Dec. 30, 2024, the entire contents of which are incorporated herein by reference.

### TECHNICAL FIELD

The present disclosure relates to a vehicle air conditioning system including a driving system that enable individual air conditioning control for each seat.

### BACKGROUND

A vehicle air conditioning system is an essential device that controls the temperature and airflow in the vehicle interior to maintain the comfort of passengers. Particularly, minimizing power consumption is a very important design element in electric and hybrid electric vehicles. In this regard, technology has been continuously developed to individually control the air conditioning system depending on the presence of a passenger in a seat, thereby reducing unnecessary energy waste or consumption. Providing independent air conditioning only for the driver seat when the passenger seat is empty plays an important role in maximizing energy efficiency in the vehicle.

For a vehicle air conditioning system of a related art, a method was employed in which drive units were individually installed for each seat to independently control the vents for the driver seat and passenger seats. This method had an advantage of customizing air conditioning for each seat, improving driver convenience and allowing for fine adjustment of air flow. Particularly, for a luxury vehicle or electric vehicle, a method of providing air conditioning only for the driver seat when the passenger seat is empty was widely used to save energy, reducing power consumption and improving battery efficiency.

However, in the related art, because the drive units had to be installed on the driver seat and the passenger seat, respectively, the structure was complex and the number of components increased, which thereby increased the vehicle's weight and manufacturing costs. Particularly, even when air conditioning was to be provided only to the driver seat to save power consumption, unnecessary components were added due to the drive unit installed on the passenger seat, and it had a negative effect on reducing the vehicle's weight. Such problems were even more prominent in vehicles where energy efficiency is important, such as electric and hybrid vehicles.

The above information disclosed in this Background section is only to enhance understanding of the background of the present disclosure, and therefore it may contain information that does not form the prior art that is already known to a person of ordinary skill in the art.

### SUMMARY

The present disclosure provides a vehicle air conditioning system having a structure in which a foot door for a driver seat, a foot door for a passenger seat, and a defrost door are configured to rotate together via a single cam, thereby minimizing the number of components and reducing manufacturing costs and design complexity of the vehicle, while implementing individual air conditioning control.

Another aspect of the present disclosure provides a vehicle air conditioning system having a structure in which a door unit for a driver seat and a door unit for a passenger seat are arranged coaxially to each other, increasing space utilization of the air conditioning system and maximizing air conditioning efficiency, thereby improving the fuel efficiency and electric efficiency of an environmentally friendly vehicle.

The objects or aspects of the present disclosure are not limited to the foregoing, and other objects of the present disclosure not mentioned herein may be understood based on the following description, and may be understood more clearly through the embodiments of the present disclosure. In addition, the objects of the present disclosure may be realized by means and combinations thereof indicated in the claims.

In one aspect of the present disclosure, a vehicle air conditioning system includes: an air conditioner case, a cam mounted to the air conditioner case, a first lever unit having a first end coupled to the cam, a second lever unit disposed adjacent to the first lever unit and having a first end coupled to the cam, a first door unit coupled to a second end of the first lever unit and configured to open and close a first foot vent, and a second door unit coupled to a second end of the second lever unit and configured to open and close a second foot vent. Here, the first door unit and the second door unit may be arranged coaxially with each other and may be rotated in conjunction with the cam via the first lever unit and the second lever unit.

In an embodiment of the present disclosure, the vehicle air conditioning system may include a defrost lever having one end coupled to the cam, and a defrost door coupled to the defrost lever and configured to open and close a defrost vent.

In another embodiment of the present disclosure, the cam may include a plurality of slots. Here, the plurality of slots may include: a first guide slot along which the first end of the first lever unit moves to sequentially position the first door unit in a first closing section A, a first partially opening section B, a first set section C, a first fully opening section D, a second set section E, a second partially opening section F, and a second closing section G; a second guide slot along which the first end of the second lever unit moves to sequentially position the second door unit in a third closing section A′, a third partially opening section B′, a third set section C′, a second fully opening section D′, a fourth set section E′, a fourth partially opening section F′, and a fourth closing section G′; and a third guide slot along which the first end of the defrost lever moves to sequentially position the defrost door in a first blocking section A′′, a second blocking section B″, a third blocking section C″, a fourth blocking section D″, a fifth blocking section E″, a fifth partially opening section F″, and a third fully opening section G″.

In still another embodiment of the present disclosure, as the cam rotates, the first lever unit may sequentially move along the first closing section A, the first partially opening section B, the first set section C, the first fully opening section D, the second set section E, the second partially opening section F, and the second closing section G in the first guide slot, and, in response to movement of the first lever unit, the second lever unit may sequentially move along the third closing section A′, the third partially opening section B′, the third set section C′, the second fully opening section D′, the fourth set section E′, the fourth partially opening section F′, and the fourth closing section G′ in the second guide slot.

In yet another embodiment of the present disclosure, when the first lever unit is positioned in the first set section C, the second lever unit is positioned in the third set section C′, and the defrost lever is positioned in the third blocking section C″, the first door unit may open the first foot vent, the second door unit may block the second foot vent, and the defrost door may block the defrost vent.

In still yet another embodiment of the present disclosure, the first lever unit may include a first foot lever having a first end coupled to the cam, and a first foot arm coupled to a second end of the first foot lever.

In a further embodiment of the present disclosure, the first door unit may include a first rotation shaft coupled to the first foot arm and including a through hole, and a first foot door mounted to the first rotation shaft.

In another further embodiment of the present disclosure, the vehicle air conditioning system may include a separator disposed between the first door unit and the second door unit.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are now described in detail with reference to certain embodiments thereof illustrated in the accompanying drawings which are given herein below by way of illustration only, and thus are not limitative of the present disclosure, and wherein:

FIG. 1 is a perspective view of a vehicle air conditioning system, as an embodiment of the present disclosure;

FIG. 2 is a perspective view of a double-door structure, as an embodiment of the present disclosure;

FIG. 3 is a side view taken along line A-A′ of FIG. 2, as an embodiment of the present disclosure;

FIG. 4 is a side view of a first door unit and a second door unit being separated by a separator, as an embodiment of the present disclosure; and

FIG. 5 is a side view of a cam, as an embodiment of the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, various embodiments of the present disclosure are described in detail with reference to the accompanying drawings. The embodiments of the present disclosure may be modified into various forms, and the scope of the present disclosure should not be construed as being limited to the following embodiments. The embodiments are intended to facilitate understanding of the present disclosure by those having ordinary skill in the art.

Furthermore, terms such as “. . . portion,” “. . . unit,” etc. used in the present disclosure each refer to a unit that processes at least one function or operation, and may be implemented as hardware, software or a combination thereof.

The terminology used herein is for describing various exemplary embodiments only, and is not intended to be limiting. A singular representation may include a plural representation unless it represents a definitely different meaning from the context.

The terms “comprises” and/or “comprising” as used in the present disclosure mean that the cited component does not exclude the presence or addition of one or more of other components, but may further include other components unless otherwise specified. Moreover, terms such as “. . . portion,” “. . . unit,” etc. as used in the present disclosure refer to a unit that processes at least two functions or operations.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

The term “unit” or “module” as used in the present disclosure signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

A controller 70 may be implemented as a memory that stores algorithms for controlling operation of various components placed in a vehicle or data on a program that reproduces algorithms and a processor that performs the above described operation using data stored in the memory. Here, the memory and the processor may be implemented as separate chips. Alternatively, the memory and the processor may be implemented as a single chip. For example, the controller 70 may include at least two from an electronic control unit (ECU), a central processing unit (CPU), a microprocessor unit (MPU), a micro controller unit (MCU), an application processor (AP) or any form of processor well known in the art to which the present disclosure pertains.

In addition, the controller 70 may be a combination of software and hardware capable of performing calculations for at least two applications or programs to execute a method according to the embodiments of the present disclosure.

In the following description, a forward direction refers to a clockwise direction and a reverse direction refers to a counterclockwise direction, based on the drawing.

Hereinafter, embodiments are described in detail with reference to the accompanying drawings, and in the description provided with reference to the accompanying drawings, the same or corresponding components are assigned the same reference numerals, and a description thereof is not repeated.

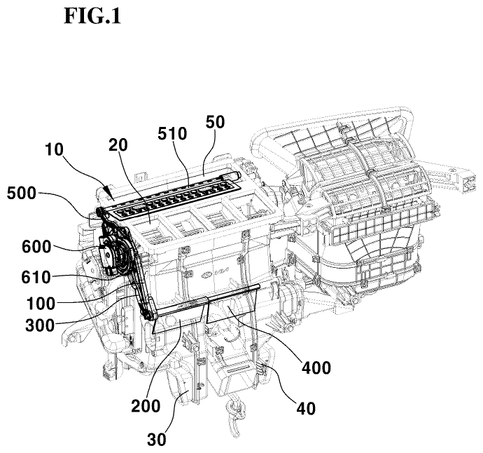

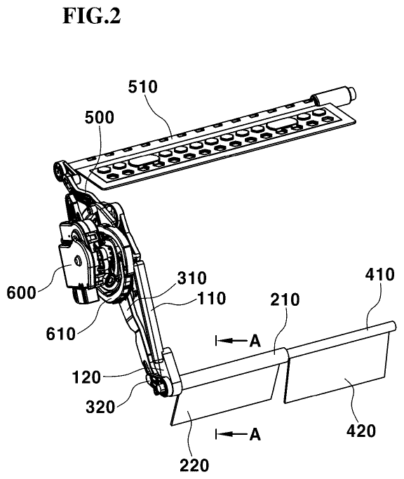

FIG. 1 is a perspective view of a vehicle air conditioning system, and FIG. 2 is an enlarged view of a double-door structure.

As an embodiment of the present disclosure, the vehicle air conditioning system having the double-door structure includes an air conditioner case 10 fluidly connected to each vent. Further, the vehicle air conditioning system includes a cam 610 and an actuator 600 mounted on an external surface of the air conditioner case 10.

The vehicle air conditioning system operates a blower unit (not shown) to introduce either outside air or recirculated air of the vehicle into the air conditioner case 10. The air introduced into the air conditioner case 10 undergoes heat exchange with a heat exchanger (not shown), or bypasses the heat exchanger and flows through a front vent 20, a defrost vent 50, a first foot vent 30, and a second foot vent 40, which are opened by the operation of the cam 610 and the actuator 600, and then is discharged into a vehicle cabin.

The outside air or recirculated air of the vehicle, which is introduced into the air conditioner case 10, is discharged to the upper front of the vehicle through the front vent 20 and to the front windshield through the defrost vent 50. Furthermore, the outside air or recirculated air, which is introduced into the air conditioner case 10, is discharged to the lower part of the driver seat through the first foot vent 30 and to the lower part of the passenger seat through the second foot vent 40.

Furthermore, the front vent 20, the defrost vent 50, the first foot vent 30, and the second foot vent 40 may be opened and closed by the actuator 600 and the cam 610 attached to the external surface of the air conditioner case 10.

The front vent 20 may be opened and closed via an electrically driven actuator or mechanism (not shown), or may be independently controlled by a drive unit (not shown) independent of the defrost vent 50, the first foot vent 30, and the second foot vent 40.

The defrost vent 50 is opened or closed according to the movement of a defrost lever 500 connected to the cam 610. More specifically, the defrost vent 50 is opened or closed according to the rotation of a defrost door 510 connected to the defrost lever 500. The defrost door 510 is rotated about a rotation shaft passing through opposite side surfaces of the air conditioner case 10 to open or close the defrost vent 50.

The first foot vent 30 is opened or closed in response to the movement of a first lever unit 100 configured to move according to the rotation of the cam 610. Furthermore, the first foot vent 30 is selectively fluidly connected to the lower part of the driver seat by a first door unit 200 connected to the first lever unit 100.

The second foot vent 40 is opened or closed depending on the position of a second lever unit 300, coupled to the cam 610 and configured to move along at least a portion of the cam 610. Furthermore, the second lever unit 300 is coupled to a second door unit 400. The second door unit 400 may selectively fluidly connect or block the second foot vent 40 depending on the position of the second lever unit 300.

In one embodiment of the present disclosure, the first foot vent 30, the second foot vent 40, and the defrost vent 50 may be opened or closed in conjunction with the rotation of the cam 610 operated by the actuator 600.

As the cam 610 rotates, the first lever unit 100 is positioned to open or close the first foot vent 30. In response to the movement of the first lever unit 100 caused by the rotation of the cam 610, the second lever unit 300 is positioned to open or close the second foot vent 40. Furthermore, the defrost door 510 also is, like the second lever unit 300 is, positioned to open or close the defrost vent 50 according to the rotation of the cam 610 in response to the position of the first lever unit 100.

The actuator 600 rotates the cam 610 coupled to the actuator 600 according to the signal of the controller 70. The actuator 600 is coupled to the cam 610 through a drive shaft. Here, the drive shaft may be couple to the cam 610 using a shaft coupling method, such as, splined shaft coupling or keyed shaft coupling.

Moreover, the actuator 600 rotates the cam 610 in a forward or reverse direction according to the signal from the controller 70 to control the open or closed state of each vent. Here, the controller 70 monitors the rotation angle of the actuator 600 in real time through a feedback device, such as an encoder. As such, the open and closed positions of the first door unit 200, the second door unit 400, and the defrost door 510 are controlled.

The cam 610 is coupled to another side surface of the actuator 600 and has a central axis and an asymmetrical surface. One side surface of the cam 610 has an asymmetrical structure with a height difference, allowing the plurality of levers to move integrally or together along the one side surface as the cam 610 rotates. In other words, as the cam 610 rotates, its asymmetrical side surface—having a height difference—causes the plurality of levers to move together along the surface Specifically, as the cam 610 rotates, the first lever unit 100, the second lever unit 300, and the defrost lever 500, each coupled to the cam 610, move along corresponding slots formed on the one side surface of the cam 610. Due to the asymmetrical surface structure, the distances from the central axis to each of the first lever unit 100, the second lever unit 300, and the defrost lever 500 change during rotation.

As the distances from the central axis change, the ends of the first lever unit 100, the second lever unit 300, and the defrost lever 500 that face the cam 610 may move along the slots, whereby the other ends (e.g., the opposite ends) of the first lever unit 100, the second lever unit 300, and the defrost lever 500 may rotate. To describe in detail, the first door unit 200 is rotated according to the movement of the first lever unit 100, the second door unit 400 is rotated according to the movement of the second lever unit 300, and the defrost door 510 is rotated according to the movement of the defrost lever 500.

In an embodiment, the cam 610 includes a first guide slot 620 that serves as a movement path of the first lever unit 100, a second guide slot 630 that serves as a movement path of the second lever unit 300, and a third guide slot 640 that serves as a guiding path for the defrost lever 500.

The first guide slot 620 may have an arch-like shape formed from the outermost edge of the cam 610, extending along the top portion of the cam 610, and gradually approaching toward the center of the cam 610.

Moreover, the first lever unit 100 is coupled to the first guide slot 620. Furthermore, in the first guide slot 620, the one end of the first lever unit 100 is sequentially positioned in a first closing section A, a first partially opening section B, a first set section C, a first fully opening section D, a second set section E, a second partially opening section F, and a second closing section G as the cam 610 rotates.

More specifically, when the first lever unit 100 is positioned in the first closing section A and in the second closing section G, the first door unit 200 is closed, and when the first lever unit 100 is positioned in the first partially opening section B and in the second partially opening section F, the first door unit 200 has an opening amount of a set value. Moreover, when the first lever unit 100 reaches the first fully opening section D, the first door unit 200 is fully opened, and when the first lever unit 100 moves to the first set section C and to the second set section E, the first door unit 200 is opened. In the first guide slot 620, the first closing section A may be a portion adjacent to the outermost edge of the cam 610 and may have the largest radius from the center of the cam 610. Furthermore, the second closing section G may be a portion closest to the center of the cam 610 and may have the smallest radius from the center of the cam 610.

The second guide slot 630, positioned adjacent to the first guide slot 620, may have a shape of a repeatedly curved line. It extends away from a point closest to the center of the cam 610 to a certain extent in a radial direction, then curves toward the center of the cam 610, then curves away from the center of the cam 610, and then curves back again toward the center of the cam 610.

The second guide slot 630 defines a path along which the one end of the second lever unit 300 coupled thereto moves. Moreover, in the second guide slot 630, the one end of the second lever unit 300 is sequentially positioned in a third closing section A′, a third partially opening section B′, a third set section C′, a second fully opening section D′, a fourth set section E′, a fourth partially opening section F′, and a fourth closing section G′ as the cam 610 rotates.

When the second lever unit 300 is positioned in the third closing section A′ or in the fourth closing section G′, the second door unit 400 is kept being closed. When the second lever unit 300 is positioned in the third partially opening section B′ or in the fourth partially opening section F′, the second door unit 400 has a set opening amount. Moreover, when the second lever unit 300 reaches the second fully opening section D′, the second door unit 400 is fully opened, and when the second lever unit 300 moves to the third set section C′ or to the fourth set section E′, the second door unit 400 is kept being opened.

The portion from the third closing section A′ to the third partially opening section B′ gradually extends away from the center of the cam 610 in the radial direction, and the portion from the third partially opening section B′ to the third set section C′ extends toward the center of the cam 610. The portion from the third set section C′ to the fourth set section E′ has a shape in which the portion from the third set section C′ to the second fully opening section D′ extends away from the center of the cam 610 in the radial direction, and the portion from the second fully opening section D′ to the fourth set section E′ extends toward the center of the cam 610.

The portion from the fourth set section E′ to the fourth closing section G′ has the same shape as the portion from the third set section C′ to the fourth set section E′, as extending away from the center of the cam 610 and then curved back toward the center of the cam 610.

The third guide slot 640 has an arch-like shape formed from the outermost edge of the cam 610, extending along the bottom portion of the cam 610, and gradually approaching the center of the cam 610 at a portion adjacent to the first guide slot 620.

The third guide slot 640 defines a path along which the defrost lever 500 coupled thereto moves. In the third guide slot 640, the one end of the defrost lever 500, which is coupled thereto, moves along the slot to sequentially position the defrost door 510 in a first blocking section A″, a second blocking section B″, a third blocking section C″, a fourth blocking section D″, a fifth blocking section E″, a fifth partially opening section F″, and a third fully opening section G″.

In the third guide slot 640, the one end of the defrost lever 500 is sequentially positioned in the first blocking section A″, the second blocking section B″, the third blocking section C″, the fourth blocking section D″, the fifth blocking section E″, the fifth partially opening section F″, and the third fully opening section G″.

When the one end of the defrost lever 500 is positioned in the first blocking section A″, in the second blocking section B″, in the third blocking section C″, in the fourth blocking section D″, or in the fifth blocking section E″, the defrost door 510 is closed. More specifically, while the one end of the defrost lever 500 is sequentially positioned in the first blocking section A″, the second blocking section B″, the third blocking section C″, the fourth blocking section D″, and the fifth blocking section E″, the defrost door 510 remains in a closed state as initially positioned in the first blocking section A″ because the radius of the third guide slot 640 does not change throughout these sections.

As described above, in the first to third guide slots 620, 630, 640, the opening section refers to an area in which the door is opened by 80% or more in response to the rotation of the lever unit coupled to the slot, and the closing section or the blocking section refers to a state in which the door is opened by 20% or less.

The first lever unit 100 having one end coupled to the first guide slot 620 may be located inside the air conditioner case 10. More specifically, at least a portion of the first lever unit 100 may pass through the air conditioner case 10 to be coupled to the first guide slot 620 in the cam 610 which is located at the external side surface of the air conditioner case 10.

Furthermore, the first lever unit 100 comprises a first foot lever 110 having one end coupled to the cam 610, and a first foot arm 120 coupled to another end of the first foot lever 110.

The one end of the first foot lever 110 is coupled to the first guide slot 620. The first foot lever 110 may be pin-coupled to the first guide slot 620 using a pin formed at the one end of the first foot lever 110 and protruding toward the first guide slot 620. The other end of the first foot lever 110 may be coupled to the first foot arm 120. A pin is formed on one end of the first foot arm 120, protruding toward the first foot lever 110 to be inserted into a groove in the first foot lever 110, thereby allowing the first foot arm 120 to rotate together with the first foot lever 110. Furthermore, another end of the first foot arm 120 is connected to the first door unit 200 to rotate the first door unit 200.

The first door unit 200 opens and closes the first foot vent 30 by the rotation of the first foot arm 120. The first door unit 200 comprises a first rotation shaft 210 coupled to the first foot arm 120 and including a through hole 211, and a first foot door 220 mounted to the first rotation shaft 210.

The first rotation shaft 210 may be integrally coupled to the first foot arm 120 and may extend from one side surface of the first foot arm 120. Moreover, the first rotation shaft 210 may be integrated with the first foot door 220. The first foot door 220 rotates together with the first rotation shaft 210 to open and close the first foot vent 30.

The second lever unit 300 coupled to the second guide slot 630 is positioned adjacent to the first lever unit 100. Furthermore, the second lever unit 300 comprises a second foot lever 310 having one end coupled to the second guide slot 630, and a second foot arm 320 coupled to another end of the second foot lever 310.

The one end of the second foot lever 310 may be coupled to the second guide slot 630 in various ways. As an example, the one end of the second foot lever 310 may have a pin protruding toward the second guide slot 630, and the second foot lever 310 may be coupled to the second guide slot 630 through the pin. As another example, a roller ball may be attached to the one end of the second foot lever 310, and the roller ball may be inserted into the second guide slot 630. When a roller ball is provided at the one end of the second foot lever 310, the roller ball may rotate and move within the second guide slot 630.

The second foot arm 320 may be connected to the other end of the second foot lever 310 using a pin protruding from the second foot arm 320 toward the second foot lever 310 and coupled to a corresponding groove formed in the second foot lever 310.

Moreover, the second foot arm 320 may be coupled to the second door unit 400 and be integrally rotated with the second door unit 400. Furthermore, the second door unit 400 is integrally rotated with the second foot arm 320. The second door unit 400 comprises a second rotation shaft 410 extending from one side end of the second foot arm 320 to be inserted into the through hole 211 formed in the first rotation shaft 210, and a second foot door 420 coupled to the second rotation shaft 410.

The second rotation shaft 410 passes through the through hole 211 formed in the first rotation shaft 210 to extend in a length direction of the first rotation shaft 210. Moreover, the second rotation shaft 410 is arranged coaxially with the first rotation shaft 210.

The defrost lever 500 connected to one end of the third guide slot 640 may be positioned to penetrate opposite side surfaces of the air conditioner case 10. Furthermore, the defrost lever 500 is coupled to the defrost door 510, and the defrost door 510 rotates with respect to the defrost lever 500. Therefore, when the defrost lever 500 is rotated according to the rotation of the cam 610, the defrost door 510 rotates integrally with the defrost lever 500 to open or block the defrost vent 50.

As such, in one embodiment of the present disclosure, the first door unit 200 and the second door unit 400 are arranged coaxially with each other, and the first lever unit 100 moves within the first guide slot 620 as the cam 610 rotates. The second lever unit 300 is positioned in the second guide slot 630 at a position corresponding to the first lever unit 100, and the defrost lever 500 is positioned in the third guide slot 640 at a position corresponding to the first lever unit 100.

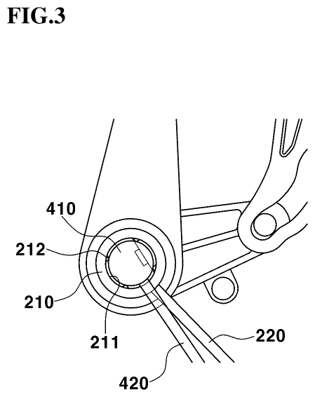

FIG. 3 is a side view taken along line A-A′ of FIG. 2.

As an embodiment of the present disclosure, the first rotation shaft 210 may have a cylindrical shape and have formed therein the through hole 211. The first rotation shaft 210 may be coupled to the first foot arm 120, or may be integrated with the first foot arm 120.

The first foot door 220 may be coupled to the first rotation shaft 210. Or, the first foot door 220 may be integrated with the first rotation shaft 210. Furthermore, the first foot door 220 may have a flat shape.

The second rotation shaft 410 is inserted into the through hole 211 formed in the first rotation shaft 210. Here, the outer diameter of the second rotation shaft 410 may be smaller than the inner diameter of the first rotation shaft 210. Furthermore, one side of the second rotation shaft 410 may be coupled to the second foot arm 320 and another side of the second rotation shaft 410 may be inserted into one side surface of the air conditioner case 10. Accordingly, the second foot door 420 coupled to the second rotation shaft 410 rotates about the second rotation shaft 410.

Moreover, the second rotation shaft 410 inserted into the through hole 211 may be positioned at a predetermined distance from the inner circumferential surface of the first rotation shaft 210. More specifically, the inner circumferential surface of the first rotation shaft 210 may have a protrusion 212 protruding inwardly from the inner surface of the first rotation shaft 210. A plurality of protrusions 212 may be provided at predetermined intervals on the inner circumferential surface of the first rotation shaft 210. The protrusions 212 may be brought into contact with the second rotation shaft 410, and owing to the protrusions 212, the second rotation shaft 410 inserted into the through hole 211 may keep a predetermined distance from the inner circumferential surface of the first rotation shaft 210.

The structure in which the second rotation shaft 410 is inserted into the through hole 211 in the first rotation shaft 210 allows the first rotation shaft 210 and the second rotation shaft 410 to be arranged coaxially with each other. The first foot door 220 rotates in conjunction with the second foot door 420 when the cam 610 rotates, but the rotational direction thereof may be independent of the second foot door 420.

More specifically, the first foot door 220 and the second foot door 420 may rotate in a same direction, or may rotate in opposite directions. As an example, the first foot door 220 may rotate in the forward direction to open the first foot vent 30, and the second foot door 420 may rotate in the forward direction to open the second foot vent 40. As another example, the first foot door 220 may rotate in the forward direction to open the first foot vent 30, and the second foot door 420 may rotate in the reverse direction to block the second foot vent 40.

In other words, according to the present disclosure, the first door unit 200 and the second door unit 400 are arranged coaxially with each other, allowing the first door unit 200 and the second door unit 400 to rotate in conjunction with the cam 610 via the first lever unit 100 and the second lever unit 300.

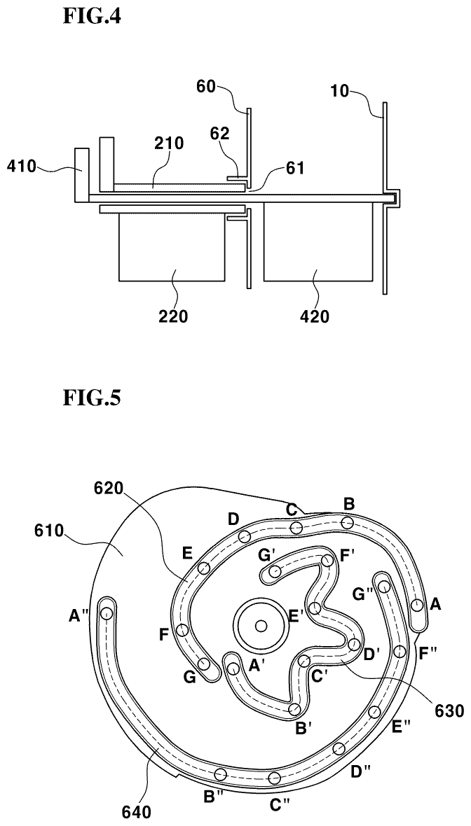

FIG. 4 illustrates a state in which the first door unit 200 and the second door unit 400 are separated from each other by a separator 60.

As one embodiment of the present disclosure, a partition 60 is placed inside the air conditioner case 10 to partition the internal space in the air conditioner case 10. Moreover, air introduced into the air conditioner case 10 is divided by the partition to flow to the left and right sides, respectively, in the vehicle cabin.

The partition 60 may be a separator. The separator 60 may be disposed between the first foot door 220 and the second foot door 420 to partition the internal air passage of the air conditioner case. Air introduced into the left space in the air conditioner case 10, with respect to the separator 60, is discharged to the lower part of the driver seat through the first foot vent 30 when the first foot door 220 is opened. Air introduced into the right space in the air conditioner case 10, with respect to the separator 60, flows to the lower part of the passenger seat through the second foot vent 40 when the second foot door 420 is opened.

Moreover, the separator 60 comprises a mounting portion 62 in which the first rotation shaft 210 is mounted, and an opening 61 into which the second rotation shaft 410 is inserted.

The mounting portion 62 extends from one side surface of the separator 60 toward the first foot arm 120. The mounting portion 62 is configured to support the first rotation shaft 210. Furthermore, a bearing (not shown) may be used in the mounting portion 62.

Moreover, the second rotation shaft 410 is inserted into the opening 61. Furthermore, the opening 61 may have placed therein a sealing portion (not shown) to fill the space between the opening 61 and the second rotation shaft 410.

FIG. 5 is a side view of the cam 610.

As one embodiment of the present disclosure, the cam 610 has three guide slots. With this structure, the first lever unit 100, the second lever unit 300, and the defrost lever 500 may rotate in conjunction with the rotation of the cam 610.

The controller 70 outputs a signal to control the actuator 600 in accordance with the air conditioning mode, and the actuator 600 rotates the cam 610 according to the control signal from the controller 70.

As the cam 610 rotates, the first lever unit 100 moves along the first guide slot 620, the second lever unit 300 moves along the second guide slot 630, and the defrost lever 500 moves along the third guide slot 640.

First, when the first lever unit 100 is positioned in the first closing section A, the second lever unit 300 is positioned in the third closing section A′ and the defrost lever 500 is positioned in the first blocking section A″. Here, the first foot door 220 is closed to block the first foot vent 30, the second foot door 420 is closed to block the second foot vent 40, and the defrost door 510 is closed to block the defrost vent 50. Furthermore, the front vent 20 is opened by an electric air vent (not shown), and the air introduced into the air conditioner case 10 is discharged to the upper part of the front seat through the front vent 20.

Moreover, the controller 70 positions the first lever unit 100 in the first partially opening section B to direct the air introduced into the air conditioner case 10 toward the front vent 20, the first foot vent 30, and the second foot vent 40, simultaneously. When the cam 610 rotates to position the first lever unit 100 in the first partially opening section B, the second lever unit 300 is positioned in the third partially opening section B′ and the defrost lever 500 is positioned in the second blocking section B″.

Here, the first foot vent 30 and the second foot vent 40 are opened by a set opening amount, and the front vent 20 is also opened by a predetermined opening amount. Accordingly, the air inside the air conditioner case 10 is discharged to the upper and lower parts of the front seat.

Moreover, the controller 70 may discharge air only to the upper part of the front seat and the lower part of the driver seat in order to reduce power consumption. To this end, the cam 610 is rotated to position the first lever unit 100 in the first set section C, the second lever unit 300 in the third set section C′, and the defrost lever 500 in the third blocking section C″.

Here, the first foot vent 30 is opened by a predetermined opening amount and the second foot vent 40 is blocked. Furthermore, the front vent 20 is opened by a predetermined opening amount. Accordingly, the air inside the air conditioner case 10 that has performed heat exchange flows to the upper part of the front seat and to the lower part of the driver seat.

Moreover, when the first lever unit 100 is positioned in the first fully opening section D, the second lever unit 300 is positioned in the second fully opening section D′, and the defrost lever 500 is positioned in the fourth blocking section D″. Here, the first foot vent 30 and the second foot vent 40 are fully opened and the defrost vent 50 is blocked, and thus the air inside the air conditioner case 10 is discharged to the lower part of the driver seat and to the lower part of the passenger seat.

Furthermore, when air is discharged only to the lower part of the driver seat, the controller 70 positions the first lever unit 100 in the second set section E, positions the second lever unit 300 in the fourth set section E′, and positions the defrost lever 500 in the fifth blocking section E″.

The air that flows to the left in the width direction of the air conditioner case 10 by being divided by the separator 60 may flow to the lower part of the driver seat because the first foot vent 30 is opened, but conversely, the air that flows to the right in the width direction of the air conditioner case 10 by being divided by the separator 60 cannot flow to the lower part of the passenger seat because the second foot vent 40 is blocked.

Moreover, the first lever unit 100 is positioned in the second partially opening section F so that the first foot door 220 has an opening amount of a set value. When the first lever unit 100 is positioned in the second partially opening section F, the second lever unit 300 is positioned in the fourth partially opening section F′ and the defrost lever 500 is positioned in the fifth partially opening section F″ which is closer to the center of the cam 610 than the fifth blocking section E″.

The defrost door 510 moves through the section having a same radius in the third guide slot 640 while the defrost lever 500 is sequentially positioned in the first blocking section A″, the second blocking section B″, the third blocking section C″, the fourth blocking section D″, and the fifth blocking section E″. Accordingly, the defrost door 510 is kept to be closed while the defrost lever 500 moves through the first blocking section A″, the second blocking section B″, the third blocking section C″, the fourth blocking section D″, and the fifth blocking section E″.

When the defrost lever 500 moves from the fifth blocking section E″ to the fifth partially opening section F″, the radius in the third guide slot 640 changes. More specifically, the radius becomes smaller when the defrost lever 500 is in the fifth partially opening section F″ than is in the fifth blocking section E″. Accordingly, the defrost door 510 rotates to have an opening amount of a set value as the defrost lever 500 moves from the fifth blocking section E″ to the fifth partially opening section F″.

Accordingly, the first foot vent 30 and the second foot vent 40 are partially opened, and the defrost vent 50 is partially opened by the opening amount of the set value. Therefore, the air inside the air conditioner case 10 may be discharged to the lower part of the driver seat, to the lower part of the passenger seat, and to the front windshield of the vehicle, respectively.

Lastly, so as to discharge the air that has performed heat exchange only to the front windshield of the vehicle, only the defrost vent 50 may be opened. To this end, the first lever unit 100 is positioned in the second closing section G, the second lever unit 300 is positioned in the fourth closing section G′, and the defrost lever 500 is positioned in the third fully opening section G″.

When the first lever unit 100 is positioned in the second closing section G, it is positioned closest to the center of the cam 610, and the first foot door 220 is switched to a completely closed state. Furthermore, when the second lever unit 300 is positioned in the second closing section G, the second foot door 420 rotates to completely block the second foot vent 40. When the defrost lever 500 is positioned in the third fully opening section G″, the defrost door 510 rotates in a direction of fully opening the defrost vent 50. Accordingly, the air inside the air conditioner case 10 is discharged toward the front windshield of the vehicle.

As is apparent from the above description, the present disclosure may have the following effects by the above-described elements, and combination and using relations thereof.

First, as the foot door for the driver seat, the foot door for the passenger seat, and the defrost door are configured to rotate in conjunction with one another on the single cam, the number of components of the vehicle air conditioning system may be reduced and the design and assembly processes may be simplified, reducing manufacturing costs.

Second, the door unit for the driver seat and the door unit for the passenger seat are arranged coaxially to each other, increasing the space utilization of the air conditioning system and improving the efficiency of the design of the vehicle interior.

Third, the open/close state of each door is precisely controlled using the cam including a plurality slots, optimizing the air conditioning performance inside the vehicle and improving the comfort of the passengers.

The detailed description is merely illustrative of the present disclosure. In addition, the above description shows and describes preferred embodiments of the present disclosure, but the present disclosure can be used in various other combinations, modifications, and environments. In other words, changes or modifications are possible within the scope of the idea of the disclosure disclosed herein, the scope of equivalents to the described disclosure, and/or the scope of skill or knowledge in the art. The embodiments describe the best state for implementing the technical idea of the present disclosure, and various changes required for specific application fields and uses of the present disclosure are possible. Therefore, the detailed description of the present disclosure is not intended to limit the present disclosure to the disclosed embodiments. Also, the appended claims should be construed to include other embodiments.

What is claimed is:

1. A vehicle air conditioning system, comprising:
an air conditioner case;
a cam mounted to the air conditioner case;
a first lever unit having a first end coupled to the cam;
a second lever unit disposed adjacent to the first lever unit and having a first end coupled to the cam;
a first door unit coupled to a second end of the first lever unit and configured to open and close a first foot vent; and
a second door unit coupled to a second end of the second lever unit and configured to open and close a second foot vent,
wherein the first door unit and the second door unit are arranged coaxially with each other and are rotated based on rotation of the cam via the first lever unit and the second lever unit.

2. The vehicle air conditioning system of claim 1, further comprising:
a defrost lever having a first end coupled to the cam; and
a defrost door coupled to the defrost lever and configured to open and close a defrost vent.

3. The vehicle air conditioning system of claim 2, wherein the cam comprises a plurality of slots, and
wherein the plurality of slots comprises:
a first guide slot along which the first end of the first lever unit moves to sequentially position the first door unit in a first closing section, a first partially opening section, a first set section, a first fully opening section, a second set section, a second partially opening section, and a second closing section;
a second guide slot along which the first end of the second lever unit moves to sequentially position the second door unit in a third closing section, a third partially opening section, a third set section, a second fully opening section, a fourth set section, a fourth partially opening section, and a fourth closing section; and
a third guide slot along which the first end of the defrost lever moves to sequentially position the defrost door in a first blocking section, a second blocking section, a third blocking section, a fourth blocking section, a fifth blocking section, a fifth partially opening section, and a third fully opening section.

4. The vehicle air conditioning system of claim 3, wherein the defrost lever and the defrost door are configured such that the defrost door remains in a closed state throughout movement along the first to fifth blocking sections of the third guide slot.

5. The vehicle air conditioning system of claim 3, wherein as the cam rotates,
the first lever unit sequentially moves along the first closing section, the first partially opening section, the first set section, the first fully opening section, the second set section, the second partially opening section, and the second closing section in the first guide slot, and
the second lever unit, which operates in response to movement of the first lever unit, sequentially moves along the third closing section, the third partially opening section, the third set section, the second fully opening section, the fourth set section, the fourth partially opening section, and the fourth closing section in the second guide slot.

6. The vehicle air conditioning system of claim 5, wherein as the cam rotates,
the defrost lever, which operates in response to the movement of the first lever unit, sequentially moves along the first blocking section, the second blocking section, the third blocking section, the fourth blocking section, the fifth blocking section, the fifth partially opening section, and the third fully opening section.

7. The vehicle air conditioning system of claim 6, wherein,
based on the first lever unit being positioned in the first set section, the second lever unit being positioned in the third set section, and the defrost lever being positioned in the third blocking section, the first door unit opens the first foot vent, the second door unit closes the second foot vent, and the defrost door closes the defrost vent.

8. The vehicle air conditioning system of claim 5, wherein,
when the first lever unit is positioned in the second set section, the second lever unit is positioned in the fourth set section, the defrost lever is positioned in the fifth blocking section,
the first door unit opens the first foot vent, the second door unit closes the second foot vent, and the defrost door closes the defrost vent.

9. The vehicle air conditioning system of claim 1, wherein the first lever unit comprises:
a first foot lever having a first end coupled to the cam; and
a first foot arm coupled to a second end of the first foot lever.

10. The vehicle air conditioning system of claim 9, wherein the first door unit comprises:
a first rotation shaft coupled to the first foot arm and including a through hole; and
a first foot door mounted to the first rotation shaft.

11. The vehicle air conditioning system of claim 1, wherein the second lever unit comprises:
a second foot lever having a first end coupled to the cam; and
a second foot arm coupled to a second end of the second foot lever.

12. The vehicle air conditioning system of claim 11, wherein the second door unit comprises:
a second rotation shaft coupled to the second foot arm and configured to be inserted into the through hole; and
a second foot door mounted to the second rotation shaft.

13. The vehicle air conditioning system of claim 1, comprising a separator disposed between the first door unit and the second door unit.

14. The vehicle air conditioning system of claim 1, further comprising a controller configured to control the rotation of the cam to position the first and second door units based on an air conditioning mode.
